(19) United States
(12) Patent Application Publication
(10) Pub. No.: US 2004/0095597 A1
(43) Pub. Date: May 20, 2004

(54) Method of providing print data to a printer without utilizing a graphical device interface of an operating system

(76) Inventor: Fu-Chang Lin, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,782

(22) Filed: Nov. 18, 2002

(51) Int. Cl. G06F 3/12; G06F 13/10; G06F 15/00

(52) U.S. Cl. 358/1.15; 719/321; 710/5

(57) ABSTRACT

A method of providing device-dependent print data to a printer by a computer system is disclosed. The computer system has an upper layer for controlling a graphical device interface. A printer manager is provided to decode input encoded data into the printer data without utilizing the upper layer. The printer manager has a decoder for decoding the encoded data to generate raw data and a converter for converting the raw data into the print data.

### BACKGROUND OF INVENTION

1. Field of the Invention

The present invention relates to a method for generating print data for a printer, and more particularly to a method for generating the print data without utilizing a graphical device interface (GDI) of an operating system.

2. Description of the Prior Art

Generally, a personal computer performs printer control operations according to an operating system (OS) installed therein. Please refer to FIG. 1, which a functional block diagram of a conventional personal computer system 10 performing a printer control operation on a printer 30 according to the prior art. The computer system 10 is electrically connected to the printer 30 and is capable of controlling the printer 30 to print documents. The computer system 10 comprises an operating system (OS) 12, which is Windows 95 operating system published by Microsoft Corp., and an application 14. The OS 12 comprises an upper layer 15 for controlling a graphical device interface (GDI) 16 and a lower layer 18 for controlling input/output activities. The GDI 16 is a program module provided by the operating system “Windows 95 (trade mark)” and is a “Windows (trade mark)” standard for representing graphical objects. The application 14 is a graphical processing program, such as Adobe Photoshop published by Adobe Systems Incorporated. The application 14 can read encoded data 11, such as a JPEG (joint photographic experts group), GIF (graphics interchange format), BMP (bitmap), or TIFF (tag image file format) image file, and then displays the image by decoding the encoded data 11. Generally, when a user wants to print the image of the encoded data 11, he or she must control the OS 12 to open the application 14 so as to command the application 14 to read the encoded data 11, and then select a print menu command of the application 14 to control the printer 30 to print the image of the encoded data 11. When the print command of the application 14 is generated, the GDI 16 and a printer driver 20 of the printer 30 are used to decode the encoded data 11. When the encoded data 11 is decoded, the encoded data, 11 is converted into raw data, and then the raw data are converted into print data. The print data is transmitted to the printer 30 via an input/output (I/O) driver 28 of the lower layer 18 so that the printer 30 can print the print data received from the computer system 10.

Before the encoded data 11 are decoded, the user can configure the operations of the printer 30 via a user interface 17. For example, the user can select the sheet size and printing direction via the user interface 17. The GDI 16 and the printer driver 20, thus, will decode the encoded data 11 according to configuration information of the user interface 17. Furthermore, if the computer system 10 connects to a plurality of printers, the user can select one of the printers to print the image of the encoded data 11 by using the user interface 17. Additionally, the printer driver 20 has a halftoning module 22 for converting the raw data into gray-level image data and a CMM&Screening module 24 for converting the raw data into cyan-magenta-yellow-black (CMYK) image data, and no matter the raw data is converted into the gray-level image data or into the CMYK image data, the raw data finally is converted into the print data by the halftoning module 22 or by the CMM&Screening module 24. The lower layer 18 further comprises a spooler 26 that is a software program executed on the computer system 10 to temporarily store the print data in the memory or the hard disk provided to the computer and to transfer the print data to the printer 30 according to the printing state of the printer 30.

Because the GDI is a standard graphical interface for the Microsoft Windows operating systems, every time the computer system 10 controls the printer 30 to print the image of the encoded data 11, the application 14 must be executed to display the image of the encoded data 11, and then the printer driver 20 and the both the GDI 16 of the upper layer 15 must be used to convert the encoded data 11 into the print data. It is inconvenient for the people who just want to print the image of the encoded data 11 without displaying the image (i.e. using the application 14).

### SUMMARY OF INVENTION

It is therefore a primary objective of the present invention to provide a method for generating device-dependent print data without utilizing a graphical device interface (GDI) of an operating system so that the print data can be directly generated to the printer.

According to the claimed invention, a computer system has an operating system having an upper layer for controlling a graphical device interface, and a lower layer for controlling input/output activities. The method for providing the device-dependent print data to a printer by the computer system has following steps:

(a) providing a printer manager for generating the print data, the printer manager comprising a device-dependent converter for converting input data into device-dependent output data;

(b) providing encoded data to the printer manager;

(c) the printer manager decoding the encoded data to generate raw data, and utilizing the converter to convert the raw data into the device-dependent print data without utilizing the upper layer;

(d) providing the device-dependent print data to the lower layer; and

(e) the lower layer of the operating system outputting the device-dependent print data to the printer.

It is an advantage of the present invention that the print data is device-dependent and generated without utilizing the GDI of the operating system so that the printer manager is capable of directly generating the print data to the printer without displaying the image and selecting the printer to perform the print operation.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a conventional personal computer system performing a printer control operation on a printer according to the prior art.

FIG. 2 is a functional block diagram of the computer system in FIG. 1 adapting the method of the present invention.

### DETAILED DESCRIPTION

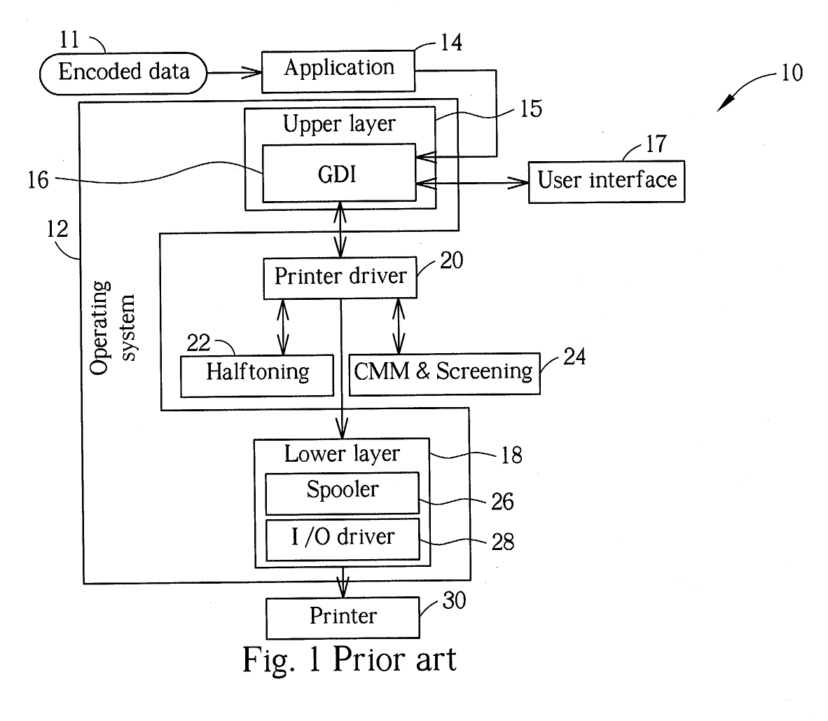

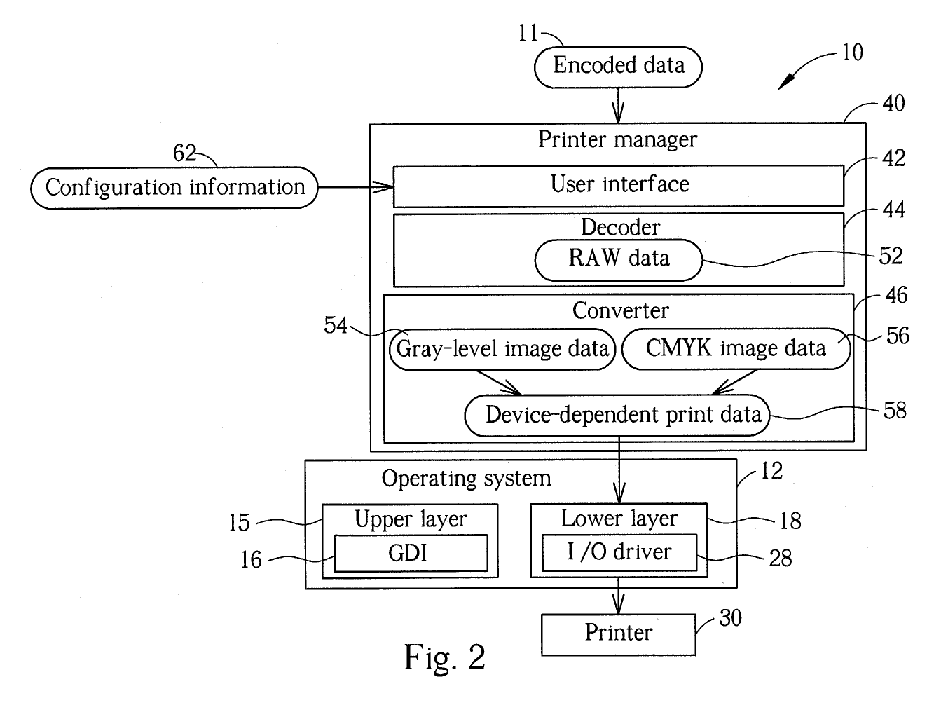

Please refer to FIG. 2, which is a functional block diagram of the computer system 10 in FIG. 1 adapting the method of the present invention. A printer manager 40 is provided to convert the encoded data 11 so as to generate device-dependent print data 58 to the printer 30. When the encoded data 11 is provided to the printer manager 40, the printer manager 40 decodes the encoded data 11 to generate raw data 52. The printer manager 40 is installed in the computer system 10 and comprises a user interface 42 for configuring the printer manager 40, a decoder 44 for decoding the encoded data 11 into the raw data 52, and a device-dependent converter 46 for converting the raw data 52 into the device-dependent print data 58. The device-dependent print data 58 will be transmitted to the lower layer 18 of the operating system 12, and then the lower layer 18 outputs the device-dependent print data 58 to the printer 30 so that the printer 30 can print the print data 58.

Note that the printer manager 40 generates the print data 58 without utilizing the upper layer 15 of the operating system 12, so no printer driver like the printer driver 20 in FIG. 1 is needed while the printer manager 40 generates the print data 58. When the user wants to control the printer 30 to print the image of encoded data 11, the only thing he or she needs to do is to drag and drop the encoded data 11 into a shortcut of the printer manager 40 or to double-click on the encoded data 11 so as to activate the printer manager 40 to convert the encoded data 11 into the print data 58. Once the print data 58 is generated and transmitted to the printer 30, the printer 30 can print the print data 58 automatically.

To fit various print requirements, the user interface 42 is used to configure the printer manager 40. When the printer manager 40 starts to decode the encoded data 11, the user interface 42 appears on the screen of the computer system 10 so that the user can configure follow-up operations of the printer manager 40 and the converter 46 will convert the raw data 52 into the device-dependent print data 58 according to configuration information of the user interface 42. For example, the user can control the printer 30 to operate in a monochrome print mode or in a color print mode via the user interface 42. If the printer 30 is controlled to operate in the monochrome print mode, the converter 46 converts the raw data 52 into gray-level image data 54 and then converts the gray-level image data 54 into the device-dependent print data 58. If the printer 30 is controlled to operate in the color print mode, the converter 46 converts the raw data 52 into cyan-magenta-yellow-black (CMYK) image data 56 and then converts the CMYK image, data 56 into the device-dependent print data 58. Note that the print data 58 is device-dependent, the print data 58 is only available for the printer 30 or for the printers having same type as the printer 30. If the print data 58 is transmitted to a different type of printer, the printer may not be capable of printing the print data 58 correctly.

In contrast to the prior art, the present invention provides a printer manager in a computer system to generate and provide device-dependent print data to a printer without utilizing a graphical device interface (GDI) of an operating system. Therefore, no graphical application and printer driver are needed to be installed in the computer system. The procedure of printing image for users, thus, can be simplified.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of providing device-dependent print data to a printer by a computer system, the computer system comprising:
an operating system having an upper layer for controlling a graphical device interface, and a lower layer for controlling input/output activities;
the method comprising:
providing a printer manager for generating the print data, the printer manager comprising a device-dependent converter for converting input data into device-dependent output data;
providing encoded data to the printer manager;
the printer manager decoding the encoded data to generate raw data, and utilizing the converter to convert the raw data into the device-dependent print data without utilizing the upper layer;
providing the device-dependent print data to the lower layer; and
the lower layer of the operating system outputting the device-dependent print data to the printer.

2. The method of claim 1 wherein the converter converts the raw data into gray-level image data and converts the gray-level image data into the device-dependent print data.

3. The method of claim 1 wherein the converter converts the raw data into cyan-magenta-yellow-black (CMYK) image data and converts the CMYK image data into the device-dependent print data.

4. The method of claim 1 wherein the printer manager further comprises a user interface for configuring the printer manager, wherein the converter converts the raw data into the device-dependent print data according to configuration information of the user interface.

5. The method of claim 1 wherein the printer manager further comprises a compressor for compressing the device-dependent print data, and the printer comprises a decompressor for decompressing the compressed device-dependent print data.

6. The method of claim 1 wherein the encoded data is stored in a joint photographic experts group OPEG) format.

7. The method of claim 1 wherein the encoded data is stored in a graphics interchange format (GIF).

8. The method of claim 1 wherein the encoded data is stored in a bitmap (BMP) format.

9. The method of claim 1 wherein the encoded data is stored in a tag image file format(TIFF).
